(19) United States
(12) Patent Application Publication
(10) Pub. No.: US 2016/0359198 A1
(43) Pub. Date: Dec. 8, 2016

(54) AUTOCLAVABLE CFX CELL

(71) Applicant: Greatbatch Ltd., Clarence, NY (US)

(72) Inventors: HONG GAN, Miller Place, NY (US); Rui Guo, Williamsville, NY (US)

(73) Assignee: Greatbatch Ltd., Clarence, NY (US)

(21) Appl. No.: 14/148,061

(22) Filed: Jan. 6, 2014

Related U.S. Application Data
(60) Provisional application No. 61/748,871, filed on Jan. 4, 2013.

(51) Int. Cl. H01M 10/0569; H01M 10/052

(52) U.S. Cl. CPC H01M 10/0569; H01M 10/052

(57) ABSTRACT

An autoclavable electrochemical cell that may be used in an implantable or external medical device is described. The anode active material comprises lithium or other material from groups IA and IIA of the Periodic Table. The cathode active material comprises carbon monofluoride, silver vanadium oxide, copper vanadium oxide, transition metal oxides, and combinations thereof. The solvent for the electrolyte has a boiling point greater than about 100° C. and is capable of wetting a surfactant free polymeric separator material such that the cell may be dimensionally and chemically stable during repeated exposures to an autoclave environment.

### CROSS-REFERENCE TO RELATED APPLICATION

This application claims priority from U.S. Provisional Patent Application Ser. No. 61/748,871, filed Jan. 4, 2013.

### FIELD OF THE INVENTION

The present invention relates to the conversion of chemical energy to electrical energy. In particular, the invention relates to an autoclavable electrochemical cell that may be used, for example, to power a medical device.

### PRIOR ART

Numerous power sources have been developed for use in implantable medical devices such as implantable neurostimulators, drug pumps, cardioverters and pacemakers. Prior to implantation, it is necessary that these medical devices be sterilized. Medical devices powered by electrochemical cells have historically been sterilized by treatment with an oxide gas such as ethylene oxide. Ethylene oxide gas was first introduced in the 1950's, and is an effective, low temperature (usually in the 50-60° C. range) chemical sterilization method. However, ethylene oxide does have limitations.

Ethylene oxide gas is a chemical agent that is designed to kill spores and other microorganisms on contact. However, for effective sterilization, the gas typically requires relatively long dwell times to allow the gas to migrate to all areas of the device. Likewise, the ethylene oxide gas sterilization method generally requires a relatively long aeration time period to ensure all the gas has been safely removed from the device. In general, a complete sterilization cycle may require as long as 16-18 hours to ensure that the sterilized medical device is safe for patient implantation.

In addition, while ethylene oxide gas is a generally reliable and safe chemical agent for sterilization when handled properly, the Occupational Safety and Health Administration (OSHA) has special handling guidelines for the oxide gas, as it is considered environmentally unsafe. Furthermore, ethylene oxide gas has been shown to be necrotic to tissue. For example, the gas may become trapped in spaces within a medical device during sterilization. The oxide gas may then eventually be released over time from the medical device into the surrounding tissue after implantation. The release of ethylene oxide gas into body tissue has been shown to cause tissue damage, sometimes resulting in severe tissue damage.

An alternative sterilization method to ethylene oxide gas treatment is autoclave, a heat sterilization method which is commonly used to sterilize surgical instruments. Autoclave is the oldest and safest sterilization method in the medical equipment industry; its only drawback is generally considered to be the relatively high temperature and increased atmospheric pressure imposed on the items being sterilized.

During autoclave, the items being sterilized are subjected to extreme heat, pressure and humidity for about 10-60 minutes. The autoclave sterilization method typically utilizes temperatures ranging from 121-148° C. (250-300° F.) in a pressure chamber at about 15 psi. The sterilization period is dependent on the temperature and size of load. In an autoclave process, microorganisms are killed by heat, and this is accelerated by the addition of moisture. Therefore, for an implantable medical device, and its electrochemical cell which powers the device, to survive the autoclave process, both the device and the electrochemical cell must be capable of withstanding the harsh environmental conditions imposed.

An electrochemical cell that powers an implantable or external medical device may comprise an anode having an anode active material of lithium or other alkali metal in addition to a cathode having a cathode active material of carbon monofluoride, silver vanadium oxide, and/or other metal oxides. In addition, a cell comprises an electrolyte generally composed of a lithium salt and an organic solvent. A separator comprised of a porous material for the passage of the electrolyte therethrough, for ionic transfer between the electrodes for generating a current, is positioned between the anode and cathode. Examples of such electrochemical cells are disclosed in U.S. Pat. No. 4,057,679 to Dey, U.S. Pat. No. 4,618,548 to Brule, and U.S. Pat. No. 4,830,940 to Keister et al. While electrochemical cells have been provided which have operating temperatures within the range of minus 55° C. to plus 225° C., as discussed in related U.S. Pat. Nos. 4,310,609 and 4,391,729, both to Liang et al. and which are assigned to the assignee of the present invention, the ability of an electrochemical cell to operate in such a temperature range does not determine whether it has the ability to withstand the increased heat, humidity and pressure that is associated with an autoclave environment.

Such prior art electrochemical cells are generally deficient for purposes of autoclaving. For instance, their compositions are such that one or more of their components may render the cell to be dimensionally and/or chemically unstable after repeated exposure to autoclave environmental conditions. As a result, the desired electrical performance of the cell may be significantly compromised.

In particular, electrochemical cells comprising a cathode active material of carbon monofluoride (CFₓ) may be constructed with an electrolyte solvent solution composed of γ-butyrolactone (GBL) and 1,2-dimethoxyethane (DME) in a 50:50 volume ratio. However, due to the low boiling point (85° C.) of 1,2-dimethoxyethane (DME), this solvent solution is not ideal for use as an electrolyte solvent when subjected to sustained increased temperatures, such as those temperatures used during an autoclave process. The relatively low boiling point of the DME solvent may cause the electrochemical cell to swell and potentially result in degradation of the cell's electrical discharge performance. In addition, the swelling of the cell due to out-gassing of the DME solvent may also result in damage to the structural integrity of the cell.

Therefore, to ensure optimal electrical performance of the cell after being subjected to a high temperature environment, as well as to improve the structural integrity of the electrochemical cell during an autoclaving process, a new and novel electrolyte formulation was developed. In a preferred embodiment, the present invention comprises an electrochemical cell having a non-aqueous electrolyte comprising a mixture of γ-butyrolactone (GBL) and diglyme solvents with a 1.0M LiBF₄ salt.

In addition to the electrolyte solution, it is important to select a separator that is composed of a material that is able to be wetted by the electrolyte. As defined herein, the term “wetted” means that a liquid, i.e., the electrolyte solution, coats a surface of a substrate, such as the surface of the separator. When sufficiently wetted by the electrolyte, ion exchange between the anode and the cathode through the separator material is possible. Furthermore, it is desired that the separator material is capable of surviving the increased temperature and mechanical constraints of the autoclave process without compromising its mechanical stability and electrolyte ionic conductivity.

Historically, a surfactant coated polypropylene separator material has been used as the preferred separator material as it facilitates the wetting of prior art CFx cells constructed having an electrolyte comprising an electrically conductive salt and a solvent of only GBL to the surface of the separator. However, if the application of the surfactant on the surface of the separator is not carefully controlled, degradation of the cell's electrical performance could result. For example, if portions of the surface of the separator are covered with too much surfactant, an undesirable increase in electrical resistance within the electrochemical cell could result. Such an increase in electrical resistance may cause degradation of the cell's electrical performance and could ultimately result in premature depletion of the cell's electrical energy. Likewise, if application of the surfactant on the surface of the separator is too thin or non-existent, insufficient wetting of the GBL electrolyte solvent to the surface of the separator wall could result and potentially comprise the electrical performance of the cell.

Therefore, what is desired is an electrochemical cell that can withstand the mechanical and environmental stresses created by an autoclave environment without compromising the cell's electrical performance. Specifically, what is desired is an electrochemical cell comprising an electrolyte formulation that ensures the structural integrity and optimal electrical performance of the cell after being subjected to autoclave conditions. More specifically, what is desired is an electrolyte formulation and separator material to be used within an electrochemical cell having a cathode active material comprising carbon monofluoride that ensures the structural integrity and optimal electrical performance of the cell after being subjected to autoclave conditions. The above and other objects, features, and advantages of the present invention will be apparent in the following detailed description of the preferred embodiments taken in conjunction with the accompanying drawings.

### SUMMARY OF THE INVENTION

The object of the present invention is, therefore, to ensure the structural integrity and optimal electrical performance of an electrochemical cell having a cathode active material comprising carbon monofluoride (CFₓ) after being subjected to autoclave conditions. This is achieved by utilizing an electrolyte comprising an electrically conductive salt in a solvent mixture of γ-butyrolactone (GBL) and diglyme. A further objective of the present invention is to provide an electrolyte comprising a lithium salt in a solvent mixture of γ-butyrolactone (GBL) and diglyme that sufficiently wets a separator comprising a surfactantless polymeric material such that the structural integrity and optimal electrical performance of the electrochemical cell is ensured after being exposed to autoclave conditions.

For that purpose, the present invention is directed to a non-aqueous equilibrated mixed solvent system for an electrolyte activating a cell having a cathode active material comprising carbon monofluoride (CFₓ), wherein the solvent system comprises a mixture of 1.0M LiBF₄ salt in a solvent mixture of GBL and diglyme. In particular, the preferred binary solvent mixture comprises between about 70 to about 30 volume percent GBL, with the remainder being diglyme in the range of about 30 to about 70 volume percent. In addition, a separator comprising a surfactant free polymeric material that is able to be wetted by the electrolyte solution and withstand the mechanical and environmental stresses of an autoclave process is provided.

These and other objects of the present invention will become increasingly more apparent to those skilled in the art by reference to the following description and to the appended drawings.

### BRIEF DESCRIPTION OF THE DRAWINGS

FIG. 1 is a graph showing electrical conductivity (mS/cm) of the electrolyte solution of the present invention as a function of volume percent diglyme solvent.

FIG. 2 is a graph illustrating the percent increase in the dimensional thickness of electrochemical cells constructed with an electrolyte and a separator of the prior art (an electrolyte comprising a lithium based salt and GBL only solvent, in addition to a surfactant coated separator) in comparison to cells constructed with an electrolyte and separator of the present invention after being subjected to autoclave environment conditions for 2 hours.

FIG. 3 is a graph comparing the depth of discharge voltage measurements of electrochemical cells of the present invention that were not subjected to autoclave environment conditions to those of the present invention that were subjected to autoclave environment conditions for 2 hours.

FIG. 4 is a graph comparing the depth of discharge voltage measurements of electrochemical cells of the prior art having an electrolyte comprised of a lithium based salt and GBL only solvent, in addition to a surfactant coated separator, that were subjected to autoclave environment conditions to cells of the present invention that were also subjected to autoclave environment conditions for 2 hours.

### DETAILED DESCRIPTION OF THE PREFERRED EMBODIMENTS

The electrochemical cell of the present invention is suitable as a power source for an implantable or external medical device. The electrochemical cell of the present invention comprises a casing, a cathode having a cathode active material, such as carbon monofluoride (CFₓ), and an anode having an anode active material comprising lithium. In addition, the electrochemical cell of the present invention comprises a non-aqueous electrolyte solution which includes a conductive salt and an organic solvent. A separator, preferably composed of a polymeric material, is positioned between the anode and cathode is also provided.

The exposure of such an electrochemical cell to elevated temperatures during repeated periods of autoclaving as described above, requires that the cell be constructed such that it remains dimensionally and chemically stable. Thus, the cell suitably should retain dimensional and chemical stability during repeated exposures of at least about one hour to a temperature of about 121° C. to about 148° C. For the purposes of this specification and the claims, the term “repeated” is meant to refer to more than one exposure. The term “dimensionally stable” refers to the ability of the cell to resist swelling. As the temperature increases, pressure inside the cell also increases. This may result in cell swelling if a cell includes an unsuitable electrolyte. For example, the case walls may undesirably bulge during such cell swelling due to increased high vapor pressure therewithin caused by out-gassing of the electrolyte components. The term “chemically stable” is meant to refer to maintenance of the chemical composition of the cell components such that performance of the cell is not significantly compromised by the autoclaving heat and other environmental conditions. For example, if the chemical composition within the cell is not “chemically stable”, exposure to an autoclave environment could result in an increase of electrical resistance within the cell, which could result in a decrease of the cell's electrical storage capacity and possible decreased cell life.

In order to minimize the generation of out-gassing within the cell and, thus, increase the dimensional stability of the cell, as a result of being exposed to an autoclave environment, the electrolyte solvent is selected to have a high boiling point of at least about 100° C. The solvent is also selected to have a dielectric constant of at least about 5 so that the cell capacity may be maintained during repeated exposures to an autoclave environment. The electrolyte solvents are also selected to be thermally stable in the presence of the electrode-active materials at the autoclave temperature. Examples of solvents which are suitable for use with cells having an anode active material of lithium and a cathode active material comprising carbon monofluoride and/or silver vanadium oxide may include, but are not limited to, diglyme, γ-butyrolactone (GBL), sulfolane, propylene carbonate, ethylene carbonate, and mixtures thereof.

The salt and solvent mixture combination of the electrolyte should be such that high electrical conductivity is provided and high thermal stability is present. The term “thermal stability” as defined herein is the ability of a material not to weaken or melt or degrade when subjected to an autoclave environment. This includes the ability of the salt not to precipitate out of the electrolyte solution upon exposure to autoclave temperatures. Suitable lithium salts may include, but are not limited to, lithium tetrafluoroborate, lithium trifluoromethane sulfonate, lithium hexafluoroarsenate, lithium hexafluorophosphate and lithium perchlorate.

Specifically, the present invention relates to minimization of swelling of the casing of electrochemical cells comprising a cathode active material of carbon monofluoride (CFₓ) after being subjected to elevated temperatures, such as an autoclave environment. This improvement in cell functionality preferably results from utilizing an electrolyte formulation comprising 1.0M LiBF₄ in a solvent solution of γ-butyrolactone (GBL) and diglyme.

As related to primary electrochemical cells, the anode and cathode undergo an oxidation-reduction reaction. Specifically, the overall discharge reaction that takes place in a Li-CFx primary cell is shown below:

Li+CFx→C+LiF

This primary cell reaction is irreversible and follows Tafel kinetics, hence rechargeability of the electrochemical cell is precluded. For primary cells, CFx is consumed. The consumption of CFx decreases the surface area available for the electrochemical reaction over the course of discharge. Furthermore, the discharge product, LiF, is generally deposited on the internal surfaces of the carbon layers left behind after electrochemical reduction leading to measurable cathode swelling.

For secondary electrochemical cells comprising a cathode active material of carbon monofluoride (CFₓ), upon being discharged in lithium anode cells, lithium ions generally intercalate into the layered carbonaceous structure to react with fluorine, which is attached to the carbon backbone either covalently or ionically. This forms lithium fluoride and the reaction is shown below:

CFx+xLi→C+xLiF

For rechargeable electrochemical cells, lithium ions exist in the electrolyte mostly as solvent solvated ions. When lithium ions intercalate into the carbon layers of carbon monofluoride (CFₓ) during discharge, solvent co-intercalation is also thought to occur. It is hypothesized that the co-intercalated solvent molecules form a solvated reaction intermediate. This intermediate generally causes destruction of the carbon structure and results in expansion of the discharged CFₓ active material. During high rate discharge conditions, a greater amount of solvent molecules co-intercalate into the layered carbonaceous structure within a shorter period of time. Such rapid co-intercalation creates a relatively high concentration of solvent molecules locally which, in turn, causes destruction or expansion of the layered structure at the local region.

The electrochemical cell of the present invention preferably possesses a sufficient energy density and discharge capacity required to meet the vigorous requirements of implantable and external medical devices. In a preferred embodiment, the anode active material is selected from Groups IA, IIA or IIIB of the Periodic Table of the Elements. The anode active material of the anode is preferably composed of the alkali metals, sodium, and potassium, etc. The most preferred anode active material comprises lithium. In addition, other anode active materials may include intermetallic compounds and alloys including, for example, Li—Si, Li—Al, Li—B and Li—Si—B alloys.

The form of the anode may vary, but preferably the anode is a thin metal sheet or foil of the anode active material, pressed or rolled on a metallic anode current collector. The anode current collector may comprise titanium, titanium alloy or nickel, to form the anode component. Copper, tungsten and tantalum are also suitable materials for the anode current collector. In an exemplary cell according to the present invention, the anode component has an extended tab or lead of the same material as the anode current collector, i.e., preferably nickel or titanium. In a preferred embodiment, the external tab or lead is integrally formed therewith such as by welding and contacted by a weld to a cell case of conductive metal in a case-negative electrical configuration. Alternatively, the anode may be formed in some other geometry, such as a bobbin shape, cylinder or pellet to allow an alternate low surface cell design.

The electrochemical cell of the present invention further comprises a cathode of at least a first electrically conductive material that serves as the other electrode of the cell. The cathode is preferably of solid materials. In a preferred embodiment, the cathode of the present invention comprises a cathode active material composed exclusively of carbon monofluoride (CFₓ). In an embodiment, the fluorinated carbon is represented by the formula (CFₓ)ₙ wherein x varies between about 0.1 to 1.9 and preferably between about 0.5 and 1.2, and (C₂F)ₙ wherein the n refers to the number of monomer units, which can vary widely.

However, electrochemical cells of the present invention may comprise a cathode having a sandwich design as described in U.S. Pat. No. 6,551,747 to Gan. The sandwich cathode design may further include a second active material of a relatively low energy density and a relatively high rate capability in comparison to the first fluorinated carbon cathode active material.

One preferred second active material is a transition metal oxide having the general formula SM₂V₂O_{y} where SM is a metal selected from Groups IB to VIIB and VIII of the Periodic Table of Elements, wherein x is about 0.30 to 2.0 and y is about 4.5 to 6.0 in the general formula. By way of illustration, and in no way intended to be limiting, one exemplary cathode active material may comprise silver vanadium oxide having the general formula AgₓV₂O_{y} in any one of its many phases, i.e., β-phase silver vanadium oxide having in the general formula x=0.35 and y=5.8, γ-phase silver vanadium oxide having in the general formula x=0.80 and y=5.40 and ∈-phase silver vanadium oxide having in the general formula x=1.0 and y=5.5, and combination and mixtures of phases thereof. For a more detailed description of such cathode active materials reference is made to U.S. Pat. No. 4,310,609 to Liang et al., which is assigned to the assignee of the present invention and incorporated herein by reference.

Another preferred composite transition metal oxide cathode material may include V₂O_{z} wherein z≦5 is combined with Ag₂O with silver in either the silver(II), silver(I) or silver(0) oxidation state and CuO with copper in either the copper(II), copper(I) or copper(0) oxidation state to provide the mixed metal oxide having the general formula CuₓAg_{y}V₂O_{z}, (CSVO). Thus, the composite cathode active material may be described as a metal oxide-metal oxide-metal oxide, a metal-metal oxide-metal oxide, or a metal-metal-metal oxide and the range of material composition found for CuₓAg_{y}V₂O_{z} is preferably about 0.01≦z≦6.5. Typical forms of CSVO are Cu_{0.16} Ag_{0.67} V₂O_{z} with z being about 5.5 and Cu_{0.5}Ag_{0.5}V₂O_{z} with z being about 5.75. The oxygen content is designated by z since the exact stoichiometric proportion of oxygen in CSVO can vary depending on whether the cathode material is prepared in an oxidizing atmosphere such as air or oxygen, or in an inert atmosphere such as argon, nitrogen and helium. For a more detailed description of this cathode active material reference is made to U.S. Pat. No. 5,472,810 and U.S. Pat. No. 5,516,340, both to Takeuchi et al., and both of which are assigned to the assignee of the present invention and incorporated herein by reference.

In a broader sense, it is contemplated by the scope of the present invention that the second active material of the sandwich cathode design may be any material which has a relatively lower energy density but a relatively higher rate capability than the first active material. In that respect, other than silver vanadium oxide and copper silver vanadium oxide, V₂O₅, MnO₂, LiCoO₂, LiNiO₂, LiMn₂O₄, TiS₂, CuS, FeS, FeS₂, CuO, copper vanadium oxide (CVO), and mixtures thereof are useful as the second active material.

Another embodiment of the present invention cell is constructed according to U.S. Pat. No. 5,639,577 to Takeuchi et al. This patent describes a cathode active blend of fluorinated carbon and a transition metal oxide. By blending is meant that the already prepared active materials of CFₓ and CSVO are comingled together in a relatively homogeneous mixture.

Cathode components for incorporation into an electrochemical cell according to the present invention may be prepared by rolling, spreading or pressing the first and/or second cathode active materials onto a suitable current collector selected from the group consisting of stainless steel, titanium, tantalum, platinum, gold, aluminum, cobalt nickel alloys, nickel-containing alloys, highly alloyed ferritic stainless steel containing molybdenum and chromium, and nickel-, chromium- and molybdenum-containing alloys. The preferred cathode current collector material is titanium. The titanium cathode current collector may have a thin layer of graphite/carbon material, iridium, iridium oxide or platinum applied thereto. Cathodes prepared as described above may be in the form of one or more plates operatively associated with at least one or more plates of anode material, or in the form of a strip wound with a corresponding strip of anode material in a structure similar to a “jellyroll”.

The electrochemical cell of the present invention preferably includes a separator placed between the anode and cathode. Such is the case when the anode is folded in a serpentine-like structure with a plurality of cathode plates disposed intermediate the anode folds and received in a cell casing or when the electrode combination is rolled or otherwise formed into a cylindrical “jellyroll” configuration.

Illustrative separator materials include fabrics woven from fluoropolymeric fibers of polyethylenetetrafluoroethylene and polyethylenechlorotrifluoroethylene used either alone or laminated with a fluoropolymeric microporous film. Other suitable separator materials may include non-woven glass, polypropylene, polyethylene, glass fiber materials, ceramics, a polytetraflouroethylene membrane commercially available under the designation ZITEX (Chemplast Inc.).

Preferably, the separator is composed of a polymeric material having a tensile strength sufficient to withstand the mechanical stresses and environmental conditions of an autoclave environment. In addition, the separator is preferably composed of a material that is able to be wetted by an electrolyte solution comprising a lithium salt and an organic solvent having a boiling point greater than 100° C., preferably a electrolyte formulation comprising 1.0M LiBF₄ in a mixture of γ-butyrolactone (GBL) and diglyme. In a preferred embodiment, the separator comprises a polypropylene membrane having a tensile strength of at least about 135 kgf/cm², in both its lateral and longitudinal dimensions. In a more preferred embodiment, the separator comprises a polypropylene membrane having a tensile strength of at least about 500 kgf/cm², in both its lateral and longitudinal dimensions. Furthermore, the separator is composed of a polypropylene material that preferably does not comprise a surfactant adhered to its surface. A preferred example of the polypropylene separator is manufactured by Celgard LLC., of Charlotte, N.C., under the designation “EZ2090”.

Historically, electrochemical cell separators comprised a layer of surfactant that was applied to the surface of the separator material, such as those of polypropylene. An example of such a surfactant coated polypropylene surfactant is Celgard 3500. The application of the surfactant to the surface of the separator material was done to increase the wetting or ensure a uniform contact of the electrolyte solution to the surface of the separator material. However, if this layer of surfactant is not correctly applied to the external surface of the separator, i.e., is too thick or too thin, the electrical performance of the electrochemical cell could be compromised. Specifically, it has been determined that if too much surfactant is applied to the surface of the separator, i.e., the surfactant layer is too thick, the internal electrical DC resistance could undesirably increase under low current density pulse conditions. Likewise, if the thickness of the surfactant on the surface of the separator is too thin or non-existent in some areas, the electrolyte solution may not adequately wet the surface of the separator. This is particularly problematic when an electrolyte solution comprised of a conductive salt and a single solvent of γ-butyrolactone (GBL) is used. Therefore, it is more desirable to utilize an electrolyte formulation that does not require a surfactant coating to facilitate wetting of the electrolyte to the surface of the separator as this provides for a more robust electrochemical cell.

In general, a suitable electrolyte comprises an inorganic, ionically conductive salt dissolved in a nonaqueous solvent or mixture of solvents. More preferably, the electrolyte comprises an ionizable alkali metal salt dissolved in a mixture of organic solvents comprising a low viscosity solvent and a high permittivity solvent. The inorganic, ionically conductive salt serves as the vehicle for migration of the anode ions to intercalate or react with the cathode active material. Preferably, the ion forming alkali metal salt is similar to the alkali metal comprising the anode.

In a preferred embodiment, the electrolyte of the electrochemical cell of the present invention comprises a solvent mixture having a boiling point greater than 100° C. and that can withstand extended periods of time in an autoclave environment without generating appreciable amounts of out-gassing by products or boiling. Furthermore, the preferred electrolyte solution is capable of wetting the surface of a high strength polypropylene separator material, preferably a separator comprising a surfactantless polypropylene having a tensile strength of at least 135 kgf/cm², more preferably a tensile strength of at least 500 kgf/cm², in both its lateral and longitudinal dimensions.

In a preferred embodiment, the electrolyte of the present invention comprises a solvent mixture of γ-butyrolactone (GBL) and diglyme. The electrolyte formulation of the present invention is unique in that the addition of diglyme allows for sufficient wetting of the electrolyte to the surface of a polymeric separator that does not have a surfactant coating. In addition, the increased boiling temperature of diglyme (162° C.) makes it an ideal electrolyte solvent for use in electrochemical cells that are exposed to high temperatures, particularly autoclave environments.

TABLE I

| 1.0M LiBF₄ | Diglyme | Diglyme | |
|---|---|---|---|
| in GBL (mL) | added (mL) | vol % ratio | Wettability Observation |
| 50 | 1 | 2.0 | No |
| 50 | 2.5 | 4.8 | No |
| 50 | 5 | 9.1 | No |
| 50 | 10 | 16.7 | No |
| 50 | 15 | 23.1 | No |
| 50 | 20 | 28.6 | No |
| 50 | 25 | 33.3 | No |
| 50 | 30 | 37.5 | Partially Wetted Surface |
| 50 | 35 | 41.2 | Completely Wetted |
| | | | Surface after 10 Seconds |

Table I shown above, details the results of a series of wettability experiments that were performed to determine how the addition of diglyme affected the wettability of an electrolyte solution 1.0M LiBF₄ and γ-butyrolactone (GBL) to the surface of a surfactantless polypropylene separator (Celgard EZ2090). In the experiment, a solution of 50 mL of 1.0M LiBF₄ and γ-butyrolactone (GBL) solvent was initially prepared. Once prepared, amounts of diglyme solvent were sequentially added to the solution of 1.0M LiBF₄ and γ-butyrolactone (GBL) solvent. After each additional amount of diglyme solvent was added to the electrolyte solution, the wettability of the resulting solution was tested against the surface of a polypropylene separator (Celgard EZ2090). As shown in the table above, partial wetting of the electrolyte to the surface of the separator occurred at about 37.5 volume percent diglyme. Complete wetting of the electrolyte solution to the surface of the separator was achieved after 10 seconds with an addition of about 41 volume percent of diglyme. The table shows that increasing the amount of diglyme to the 1.0M LiBF₄ and γ-butyrolactone (GBL) electrolyte improves the wetting of the resulting electrolyte solution to the surface of the polypropylene separator. Per the wettability study, it was discovered that increasing the volume percent of diglyme even more increased the speed at which the electrolyte solution wetted the surface of the polyproylene separator. It was determined that by adding about 55 volume percent diglyme to the 1.0M LiBF₄ and γ-butyrolactone (GBL) solution instantaneous wetting of the electrolyte to the surface of the polypropylene separator is achieved. Wettability testing was performed by soaking a sample of separator in a sample of the electrolyte solution being analyzed. The separator was determined to be “wetted” by the electrolyte solution being tested once the sample of separator became transparent in color after being exposed to the sample of electrolyte solution.

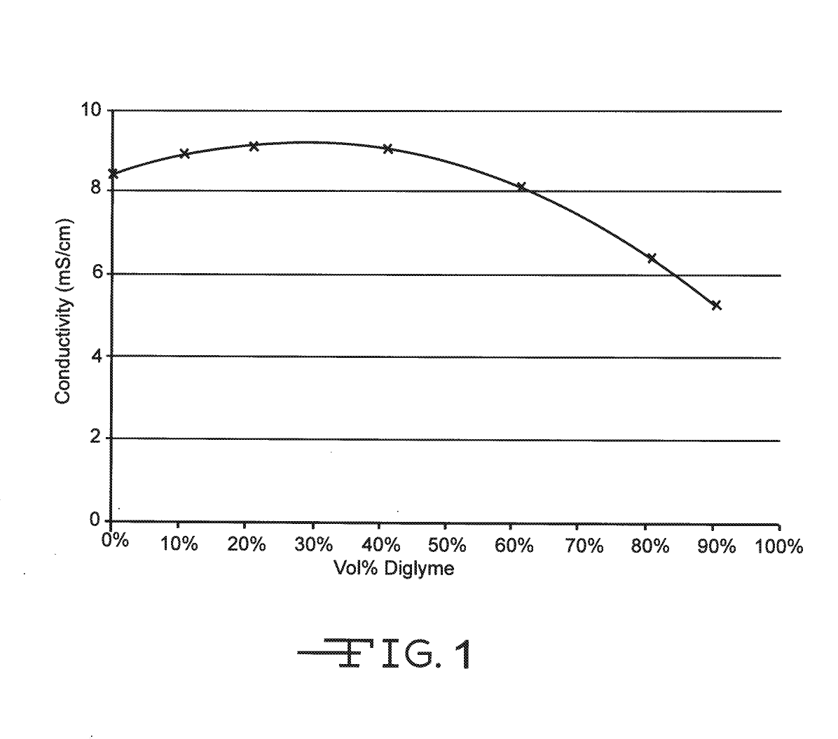

FIG. 1 illustrates the electrical conductivity (mS/cm) of an electrolyte solution comprising 1.0M LiBF₄ in a solvent mixture of γ-butyrolactone (GBL) and diglyme as a function of volume percent diglyme. As shown in the graph, the optimized electrical conductivity of the 1.0M LiBF₄γ-butyrolactone (GBL) and diglyme electrolyte occurs at about 30 volume percent diglyme. As illustrated in the graph, the electrical conductivity of the electrolyte solution remains relatively high, above 8 mS/cm, with the addition of diglyme in the range of about 10 to about 60 volume percent.

Although the optimal conductivity of the GBL:digylme electrolyte solution occurs at about 30 volume percent diglyme, a solvent mixture ratio of 45 volume percent diglyme and 55 volume percent GBL was optimally chosen because at this solvent mixture ratio, instantaneous wetting to the surface of the separator occurs. In addition, solvent mixture ratio of 45 volume percent γ-butyrolactone (GBL) and 55 volume percent diglyme was selected because the electrical conductivity at this solvent ratio is equivalent to the electrical conductivity of the prior art GBL solvent only electrolyte solution, thereby ensuring comparable electrical performance of the resulting electrochemical cell.

While an electrolyte solvent mixture comprising γ-butyrolactone (GBL) and diglyme is most preferred, it is contemplated that other low viscosity solvents may be useful with the present invention. These low viscosity solvents may include esters, linear and cyclic ethers and dialkyl carbonates such as tetrahydrofuran (THF), methyl acetate (MA), triglyme, tetraglyme, dimethyl carbonate (DMC), 1,2-diethoxyethane (DEE), 1-ethoxy, 2-methoxyethane (EME), ethyl methyl carbonate, methyl propyl carbonate, ethyl propyl carbonate, diethyl carbonate, dipropyl carbonate, and mixtures thereof.

In addition, high permittivity solvents may be utilized with the electrolyte formulation of the present invention. These high permittivity solvents may include cyclic carbonates, cyclic esters and cyclic amides such as propylene carbonate (PC), ethylene carbonate (EC), butylene carbonate, acetonitrile, dimethyl sulfoxide, dimethyl formamide, dimethyl acetamide, γ-valerolactone, N-methyl-pyrrolidinone (NMP), and mixtures thereof.

In the case of an anode comprising lithium, the alkali metal salt of the electrolyte is a lithium based salt. Although an electrolyte salt comprising LiBF₄ is most preferred, other lithium salts may be used in electrolyte formulations of the present invention. Other lithium salts that are useful as a vehicle for transport of alkali metal ions from the anode to the cathode may include LiPF₆, LiAsF₆, LiSbF₆, LiCIO₄, LiO₂, LiAlCl₄, LiGaCl₄, LiC(SO₂CF₃)₃, LiN(SO₂CF₃)₂, LiSCN, LiO₃SCF₃, LiC₆F₅SO₃, LiO₂CCF₃, LiSO₆F, LiB(C₆H₅)₄, LiCF₃SO₃, and mixtures thereof.

Therefore, the preferred embodiment of the electrolyte of the electrochemical cell of the present invention comprises a solution having a 1.0M LiBF₄ salt in a solvent mixture of 45 volume percent γ-butyrolactone (GBL) and about 55 volume percent diglyme. Furthermore, it is preferred that this electrolyte formulation be used in combination with a high strength surfactant less polypropylene separator material. This preferred combination of electrolyte and separator material minimizes the possibility of structural rupture of the cell when exposed to autoclave environments without degradation of the cell's electrical performance.

A casing header comprising a metallic lid having an opening to accommodate a glass-to-metal seal and terminal pin feedthrough for the cathode in generally used to seal the anode and cathode within the casing. An additional opening is provided for electrolyte filling. The casing header comprises elements having compatibility with the other components of the electrochemical cell and is resistant to corrosion. The cell is thereafter filled with the electrolyte solution described hereinabove and hermetically sealed such as by close-welding a titanium plug over the fill hole, but not limited thereto.

Testing of Electrochemical Cells

A series of electrical and mechanical tests were performed on control and test electrochemical cells. A total of eight electrochemical cells were constructed comprising a cathode having a cathode active material of carbon monofluoride (CFₓ) and an anode having an anode active material of lithium. Of the eight total cells that were constructed, two were control cells (identified herein as Group A) constructed using an electrolyte solution and separator of the prior art. The remaining six cells were test cells constructed utilizing the preferred electrolyte and separator material of the present invention. The control Group A cells comprised an electrolyte solution of 1.0M LiBF₄ and γ-butyrolactone (GBL) only solvent and a surfactant coated polypropylene separator (Celgard C3500). The remaining six test cells (identified herein as Group B) were constructed with the preferred 1.0M LiBF₄ GBL:diglyme (45:55 volume percent) electrolyte and the high strength, surfactant free, polypropylene separator (Celgard EZ2090).

As used herein, the term “pulse” means a short burst of electrical current of a significantly greater amplitude than that of a pre-pulse current immediately prior to the pulse. A pulse train consists of at least two pulses of electrical current delivered in relatively short succession with or without open circuit rest between the pulses. A typical current pulse is of about 15.0 mA/cm² to about 35.0 mA/cm².

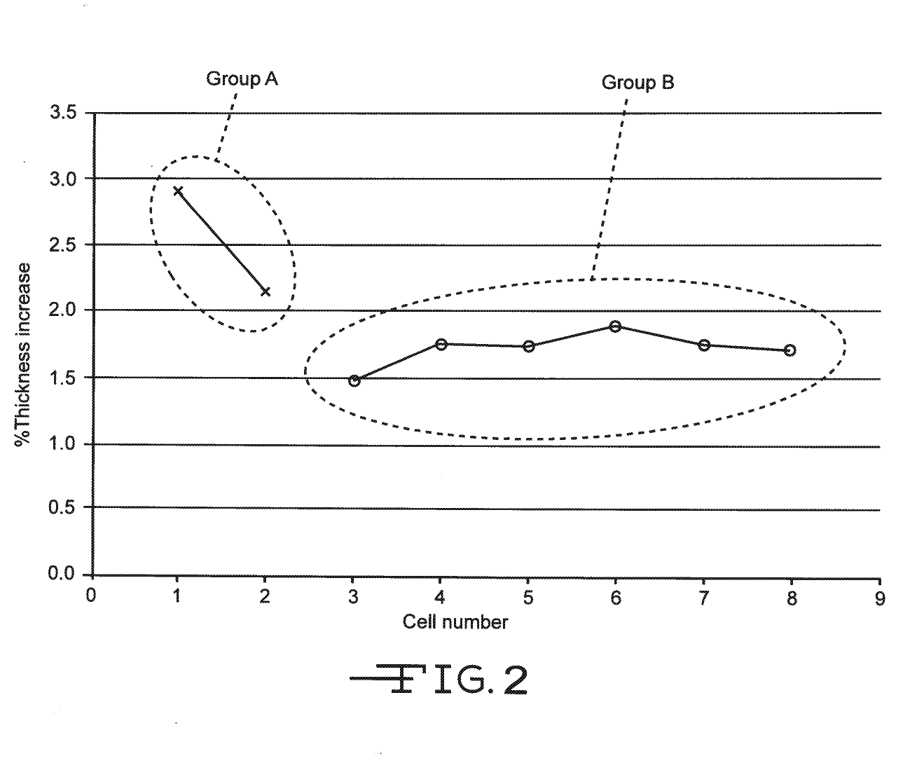

FIG. 2 illustrates the minimized dimensional expansion of the cell casing after exposure to an autoclave environment for 2 hours that was achieved by using the preferred separator and electrolyte formulation of the present invention. As the graph shows, after a two hour exposure to an autoclave environment of about 130° C., the dimensional thickness of the two control cells (Group A cells, numbers 1 and 2) had expanded by about 2.9 and 2.1 percent, respectively, from their original thickness dimensions. In contrast, the dimensional thickness of the six test cells (Group B cells, cell numbers 3 to 8) comprising the GBL:diglyme (45:55 volume percent) electrolyte and Celgard EZ2090 surfactant free polypropylene separator, had only expanded by about 1.5 percent (cell number 5) to about 1.9 percent (cell number 6). This data shows that a significant reduction in the dimensional expansion after autoclave exposure of the Group B test cells was achieved using the preferred electrolyte formulation and surfactant free polypropylene separator combination of the present invention.

In addition, the Group A and B cells were pulse discharged during which their voltage outputs were recorded as a function of percent depth of discharge (DOD). During the pulse discharge testing, a current having a current density of 1 mA per cm², expressed in terms of active cathode surface area, was applied to both the Group A and Group B cells. In addition, a single current pulse was applied to both the Group A control cells and the Group B test cells. The current pulse was applied for about 15 minutes. After application of the current pulse, the cells were then rested for a 2 week time period under a light background load. After this 2 week rest period, the pulse was again applied to the cells. This pulse and rest sequence was repeated until the electrical energy within each of the cells was depleted. The voltage output, expressed in millivolts, of the cells of Groups A and B was monitored and recorded continuously during the pulse discharge testing process.

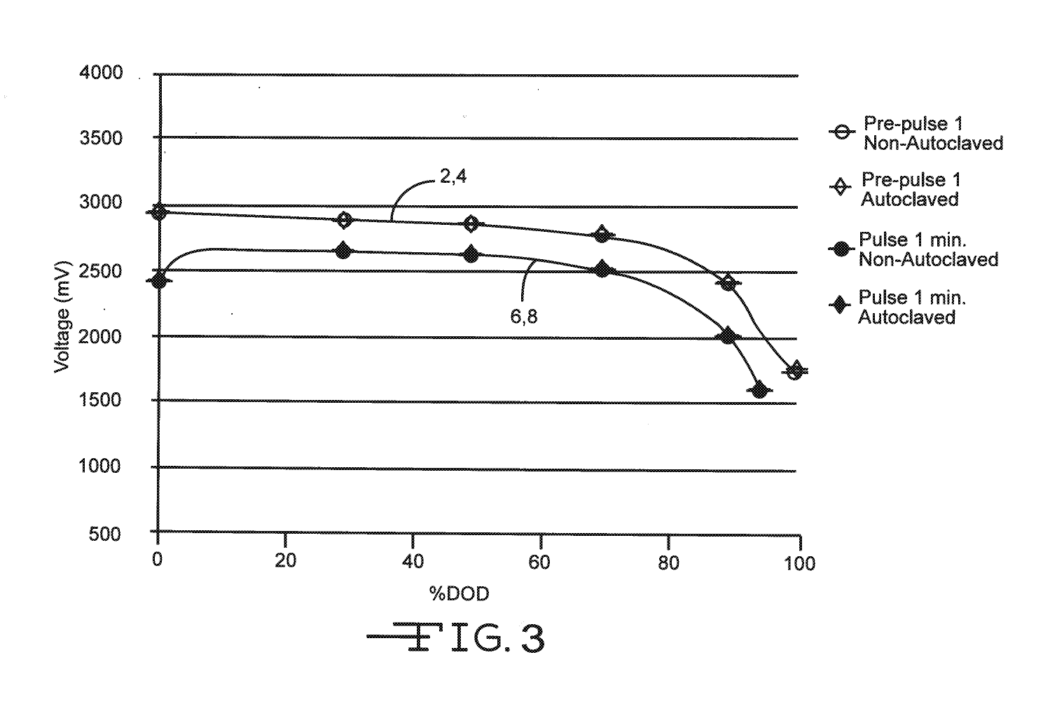

FIG. 3 graphically illustrates the results of pulse discharge testing of a subgroup of Group B test cells that had been exposed to an autoclave environment of 130° C. for 2 hours in comparison to a separate subgroup of Group B test cells that had not been exposed to the autoclave environment. Each of the two subgroups comprised two of the Group B test cells. In each of the pulse discharge tests, a current density of about 1 mA per cm² of active cathode surface area was applied to generate the pulse discharge data illustrated in the figure.

The pre-pulse voltage readings of the pulse discharged subgroup Group B cells that were exposed to the autoclave environment (curve 2) and the pre-pulse discharged subgroup Group B cells that were not exposed to the autoclave environment (curve 4), are shown in FIG. 3. As illustrated, the pre-pulse voltage readings of both subgroups of Group B cells, that were and were not exposed to the autoclave environment, were measured to be almost identical to each other, thus, both curves 2 and 4, appear as one curve in FIG. 3.

In addition, the minimum voltage readings of the pulse discharged subgroup Group B cells that were exposed to the autoclave environment (curve 6) and the minimum voltage readings of the pulse discharged subgroup Group B cells that were not exposed to the autoclave environment (curve 8) are also shown in FIG. 3. Like the pre-pulse voltage readings of curves 2 and 4, the minimum voltage readings of the subgroup of Group B that were exposed to the autoclave environment (curve 6) and the subgroup of Group B that were not exposed to the autoclave environment (curve 8) were also measured to be almost identical to each other, thus, both curves 6 and 8, appear as one curve in FIG. 3. Since the discharge voltage readings of both subgroups of Group B test cells, that were and were not exposed to an autoclave environment, appear to be almost identical, this indicates that exposure to the autoclave environment did not have a detrimental effect on the electrical discharge performance of the electrochemical cells comprised of the preferred GBL:diglyme (45:55 volume percent) electrolyte and surfactant free polypropylene separator (Celgard EZ2090) of the present invention.

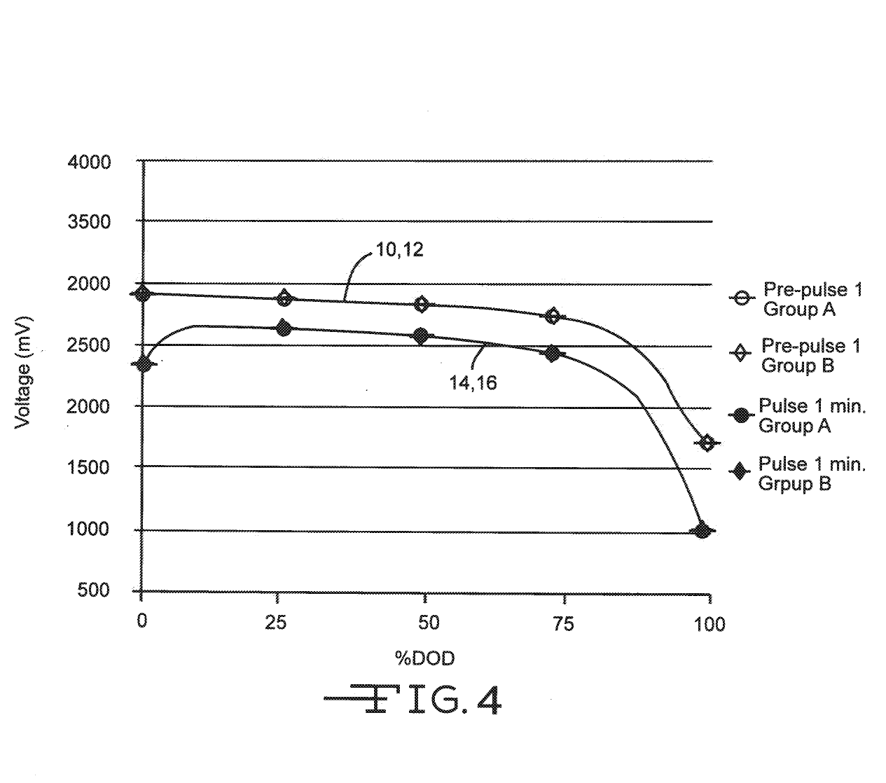

FIG. 4 graphically illustrates the results of pulse discharge testing in which autoclaved cells from the control Group A were compared to the subgroup Group B test cells that had been exposed to an autoclave environment of 130° C. for 2 hours. The control Group A cells also had been exposed to an autoclave environment of 130° C. for 2 hours. During the test, two Group B test cells were pulse discharged after being exposed to the 130° C. autoclave environment for 2 hours. For each of the pulse discharge tests, a current density of about 1 mA per cm² of active cathode surface area was applied to generate the pulse discharge data illustrated in the figure. The pre-pulse voltage readings of the pulse discharged control Group A cells, that were exposed to the two hour autoclave environment (curve 10), and the pre-pulse discharged subgroup Group B cells, that were also exposed to the two hour autoclave environment (curve 12), are shown in FIG. 4. As illustrated, the pre-pulse voltage readings of both the control Group A cells and Group B cells were measured to be almost identical to each other, thus, both curves 10 and 12, appear as one curve in FIG. 4. The minimum voltage readings of the pulse discharged control Group A cells, that were exposed to the two hour autoclave environment (curve 14) and the minimum voltage readings of the pulse discharged Group B cells that were also exposed to the two hour autoclave environment (curve 16) are shown in FIG. 4. Like the pre-pulse voltage readings of curves 10 and 12, the minimum voltage readings of the Group A (curve 14) and Group B (curve 16) were also measured to be almost identical to each other, thus, both curves 14 and 16, appear as one curve in FIG. 4. Since the discharge voltage readings of the autoclaved control Group A test cells appear to be almost identical to those of the subgroup Group B test cells that were also exposed to the autoclave environment, this also indicates that the autoclave environment does not have a detrimental effect on the discharge performance of the electrochemical cells comprised of the preferred GBL:diglyme (45:55 volume percent) electrolyte and surfactant free polypropylene separator (Celgard EZ2090) in comparison to cells of the prior art.

It is, therefore, concluded that a 1.0M LiBF₄ GBL:diglyme (45:55 volume percent) electrolyte does not compromise the structure of the electrochemical cell during autoclave. In addition, the integrity of the surfactant free polypropylene separator is not compromised by the autoclave process. Furthermore, a 1.0M LiBF₄ GBL:diglyme (45:55 volume percent) electrolyte in combination with a surfactant free polypropylene separator, such as Celgard EZ2090, is well suited for electrochemical cells comprising a cathode active material of carbon monofluoride that are subjected to autoclaving temperatures.

It is appreciated that various modifications to the inventive concepts described herein may be apparent to those of ordinary skill in the art without departing from the spirit and scope of the present invention as defined by the appended claims.

1.-12. (canceled)

13. An electrochemical cell that is configured for expose to an autoclave environment, the electrochemical cell comprising:
a) a casing;
b) an anode comprising lithium;
c) a cathode comprising carbon monofluoride;
d) a separator positioned between the anode and the cathode to prevent them from direct physical contact with each other and to thereby form an electrode assembly disposed inside the casing; and
e) an ionically conductive electrolyte provided in the casing to activate the electrode assembly, the electrolyte consisting essentially of:
i) LiBF₄;
ii) γ-butyrolactone (GBL); and
iii) diglyme,
iv) wherein, by volume percent, the ratio of GBL:diglyme ranges from 45:55 to 55:45.

14. The electrochemical cell of claim 13 wherein the carbon monofluoride is selected from C₂F and CFₓ with x ranging from about 0.1 to 1.9.

15. (canceled)

16. The electrochemical cell of claim 13 wherein the electrolyte has a dielectric constant of at least about 5.

17. The electrochemical cell of claim 13 wherein the separator comprises polypropylene having a tensile strength of at least 135 kgf/cm².

18.-23. (canceled)

24. The electrochemical cell of claim 14 wherein in the formula CFₓ for the carbon monofluoride, x ranges from about 0.5 and 1.2.

25. The electrochemical cell of claim 13 wherein the separator comprises polypropylene devoid of a surfactant.

26. The electrochemical cell of claim 13 wherein the separator is selected from the group consisting of polypropylene, fluoropolymeric fibers, polyethylenetetrafluoroethylene, polyethylenechlorotrifluoroethylene, and polytetraflouroethylene.

27. The electrochemical cell of claim 13 wherein at least one of the cathode and the anode comprise a current collector composed of a material selected from the group consisting of titanium, stainless steel, a superferrite material, nickel, cobalt nickel alloys, copper, aluminum, tungsten, gold, and platinum.

28. An electrochemical cell that is configured for expose to an autoclave environment, the electrochemical cell comprising:
a) a casing;
b) an anode comprising lithium;
c) a cathode comprising carbon monofluoride;
d) a separator positioned between the anode and the cathode to prevent them from direct physical contact with each other and to thereby form an electrode assembly disposed inside the casing; and
e) an electrolyte provided in the casing to activate the electrode assembly, the electrolyte consisting essentially of:
i) an ionically conductive lithium salt;
ii) γ-butyrolactone (GBL); and
iii) diglyme,
iv) wherein, by volume percent, the ratio of GBL:diglyme ranges from 45:55 to 55:45.

29. The electrochemical cell of claim 28 wherein the cathode has a sandwich design comprising CFₓ and silver vanadium oxide (SVO).

30. The electrochemical cell of claim 28 wherein the separator is selected from the group consisting of polypropylene, fluoropolymeric fibers, polyethylenetetrafluoroethylene, polyethylenechlorotrifluoroethylene, and polytetraflouroethylene.

31. The electrochemical cell of claim 28 wherein the separator comprises polypropylene devoid of a surfactant.

32. The electrochemical cell of claim 28 wherein the separator comprises polypropylene having a tensile strength of at least about 135 kgf/cm².

33. The electrochemical cell of claim 28 wherein the ionically conductive lithium salt is selected from the group consisting of LiBF₄, LiPF₆, LiAsF₆, LiSbF₆, LiClO₄, LiO₂, LiAlCl₄, LiGaCl₄, LiC(SO₂CF₃)₃, LiN(SO₂CF₃)₂, LiSCN, LiO₃SCF₃, LiC₆F₅SO₃, LiO₂CCF₃, LiSO₆F, LiB(C₆H₅)₄, LiCF₃SO₃, and mixtures thereof.

34. The electrochemical cell of claim 28 wherein the electrolyte has a dielectric constant of at least about 5.

35. An electrochemical cell that is configured for expose to an autoclave environment, the electrochemical cell comprising:
a) a casing;
b) an anode comprising lithium;
c) a cathode comprising carbon monofluoride;
d) a separator positioned between the anode and the cathode to prevent them from direct physical contact with each other and to thereby form an electrode assembly disposed inside the casing; and
e) an electrolyte provided in the casing to activate the electrode assembly, the electrolyte comprising:
i) an ionically conductive lithium salt selected from the group consisting of LiBF₄, LiPF₆, LiAsF₆, LiSbF₆, LiClO₄, LiO₂, LiAlCl₄, LiGaCl₄, LiC(SO₂CF₃)₃, LiN(SO₂CF₃)₂, LiSCN, LiO₃SCF₃, LiC₆F₅SO₃, LiO₂CCF₃, LiSO₆F, LiB(C₆H₅)₄, LiCF₃SO₃, and mixtures thereof; and
ii) a solvent mixture consisting essentially of γ-butyrolactone (GBL) and diglyme,
iii) wherein, by volume percent, diglyme comprises from about 30 volume percent to about 70 volume percent of the solvent mixture, the remainder comprising γ-butyrolactone.

36. An electrochemical cell that is configured for expose to an autoclave environment, the electrochemical cell comprising:
a) a casing;
b) an anode comprising lithium;
c) a cathode comprising carbon monofluoride;
d) a separator positioned between the anode and the cathode to prevent them from direct physical contact with each other and to thereby form an electrode assembly disposed inside the casing; and
e) an electrolyte provided in the casing to activate the electrode assembly, the electrolyte comprising:
i) LiBF₄;
ii) γ-butyrolactone (GBL); and
iii) diglyme,
iv) wherein, by volume percent, the ratio of GBL:diglyme ranges from 45:55 to 55:45.

37. The electrochemical cell of claim 36 wherein the cathode has a sandwich design comprising CFₓ and silver vanadium oxide (SVO).

38. The electrochemical cell of claim 36 wherein the electrolyte has a dielectric constant of at least about 5.

39. The electrochemical cell of claim 36 wherein the separator comprises polypropylene devoid of a surfactant.
